(19) United States
(12) Patent Application Publication
(10) Pub. No.: US 2008/0148312 A1
(43) Pub. Date: Jun. 19, 2008

(54) Screenplay-selectable video displaying method

(76) Inventor: Feng Ren, Beijing (CN)

Correspondence Address: TROXELL LAW OFFICE PLLC, SUITE 1404, 5205 LEESBURG PIKE, FALLS CHURCH, VA, 22041, US

(21) Appl. No.: 11/889,723

(22) Filed: Aug. 15, 2007

(30) Foreign Application Priority Data
Aug. 16, 2006 (CN) 200610112414.9

(51) Int. Cl. G06F 3/00

(52) U.S. Cl. 725/38

(57) ABSTRACT

The present invention relates to a screenplay-selectable video displaying method. According to a predetermined filename of a beginning plot, the plot is read and a video is to be played. During the playing process, the same screenplay is designed with plot files of different results. The selectable plot is used for reminding viewers to select screenplays. The massages of selections from the viewers are gathered and analyzed. A list of filenames corresponding to the screenplays stored in the head of the selectable beginning plot is retrieved and a filename of next plot is formed according to the list. A buffer plot following the plot is retrieved and the coded video content of the buffer plot is decoded and played. The buffer plot is used for saving time to retrieve next plot, by which the playing is made more fluent. Viewers can view different scenarios of a video by selecting different screenplays according to their preference.

### BACKGROUND OF THE INVENTION

1. Field of the Invention

The present invention relates to a video displaying method and, more particularly, to a screenplay-selectable video displaying method.

2. Description of the Prior Art

Media culture is more and more influential since film and television have occupied an important position in people's daily recreational lives. With the popularization of the media culture, more and more people participate in instant recreational activities so that the influence of mass opinions on recreational programs should not be neglected. Nowadays, recreational programs are heavily influenced by popularization. When a new teleplay or film is released, people will give their own opinions while watching the programs rather than just follow the track of a director or a telewriter to experience the story the director or the telewriter writes. For example, when a director directs a film in tragic way in order to affect more viewers, there may some viewers hold adverse opinions that that film should be directed in comedic way or has a more consummate ending to reflect the halcyon dreams of the viewers.

In this new era, people can communicate freely with each other. It will not only can meet the recreational need of people but also can spread films more widely if the screenplay of a film follows the mass opinions.

### SUMMARY OF THE INVENTION

In order to overcome the problems mentioned above, the present invention provides a video displaying method where screenplays are selectable by viewers.

In the screenplay-selectable video displaying method of the present invention, the plot is read from the storage according to a predetermined filename of a beginning plot and then a video is played. During the playing process, the screenplay-selectable video displaying method comprises steps of:

a. retrieving a head of the beginning plot and decide if the plot is a selectable plot or a general plot, wherein if the plot is a selectable plot, then play the plot, remind viewers to make selections on the result of following screenplay, and go to step b; if the plot is a general plot, then play the plot, form a name of next plot according to a filename of the next plot stored in the head of the beginning plot, and go to step d;

b. gathering and analyzing the messages of selections from the viewers and obtaining a corresponding result while playing the plot;

c. retrieving a filename list corresponding to the value of the corresponding screenplay stored in the head of the selectable beginning plot based on the obtained result and forming a filename of next plot according to the list;

d. retrieving a buffer plot following the plot and decoding and playing the coded content of the buffer plot;

e. judging if there is a filename of next plot while the buffer plot is played in step d, wherein if a filename can be retrieved, go to step a; if there is no filename of next plot, terminate the playing.

According to the screenplay-selectable video displaying method of the present invention, the head of the beginning plot includes information concerning types and filenames of plots of screenplays. The two types of plots include a general plot and a selectable plot. The general plot has one filename of a plot and one filename of a buffer plot, which are predetermined by a director. The selectable plot has different filenames of plots of different screenplays and one filename of a buffer plot.

According to the screenplay-selectable video displaying method of the present invention, the time for viewers to make decisions is controlled by a time controller. If the time is longer than that predetermined by the time controller, it will be regarded that viewers give up making selections by playing flow, which will play the plot of a screenplay predetermined by a director.

According to the screenplay-selectable video displaying method of the present invention, the method can be used for playing a video in a computer, a theater, and a digital television. The messages of selections are made by viewers via voters, Internet, telephones, or/and messages from mobile phones. The voter can be a group of selecting keys additively disposed on a remote controller for a digital television, a PC voter for a theater, or a mouse or certain specific keys on a keyboard for a computer. The selecting keys of the voter are “Yes” and “No” keys representing different selections of plots of different screenplays.

According to the screenplay-selectable video displaying method of the present invention, “Yes” and “No” are produced based on the messages of selections from the viewers. If viewers give up making selections or the selected result values of “Yes” and “No” are identical, “I don't know” is produced. Three results respectively corresponding to three filenames of the results “Yes”, “No”, and “I don't know” can be obtained.

When a video is viewed by only one viewer, if the viewer presses a selecting key of “Yes” or “No”, a result “Yes” or “No” will be produced correspondingly, and a corresponding filename of a plot is obtained based on the result for decoding and playing the video. If the viewer gives up selecting the keys, a result “I don't know” will be produced, and a corresponding filename of a plot is obtained according to the result for decoding and playing the video.

When a video is viewed by many viewers, for example in a theater, viewers can select and press keys within the time determined by a time controller and the messages of selections from the viewers are gathered and analyzed. If more viewers select “Yes” rather than “No”, the result “Yes” is produced. If more viewers select “No” rather than “Yes”, the result “No” is produced. A corresponding plot's filename is obtained according to the result for decoding and playing the video. If the viewers give up selecting the keys, a result “I don't know” is produced and a corresponding plot's filename is obtained based on the result for decoding and playing the video.

According to the screenplay-selectable video displaying method of the present invention, the voters can be used for selecting different selectable plots in the same video.

During the playing process according to screenplay-selectable video displaying method of the present invention, the same screenplay is designed with plot files of different results. The selectable plot is used for reminding viewers to select screenplays while the buffer plot is used for saving time to retrieve next plot, by which the playing is made more fluent. Viewers can watch different scenarios of a video by selecting different screenplays according to their preference.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is a flowchart of a screenplay-selectable video displaying method of the present invention.

FIG. 2 is a structural diagram showing one of predetermined plots of the screenplay-selectable video displaying method of an embodiment of the present invention.

### DETAILED DESCRIPTION OF THE PREFERRED EMBODIMENTS

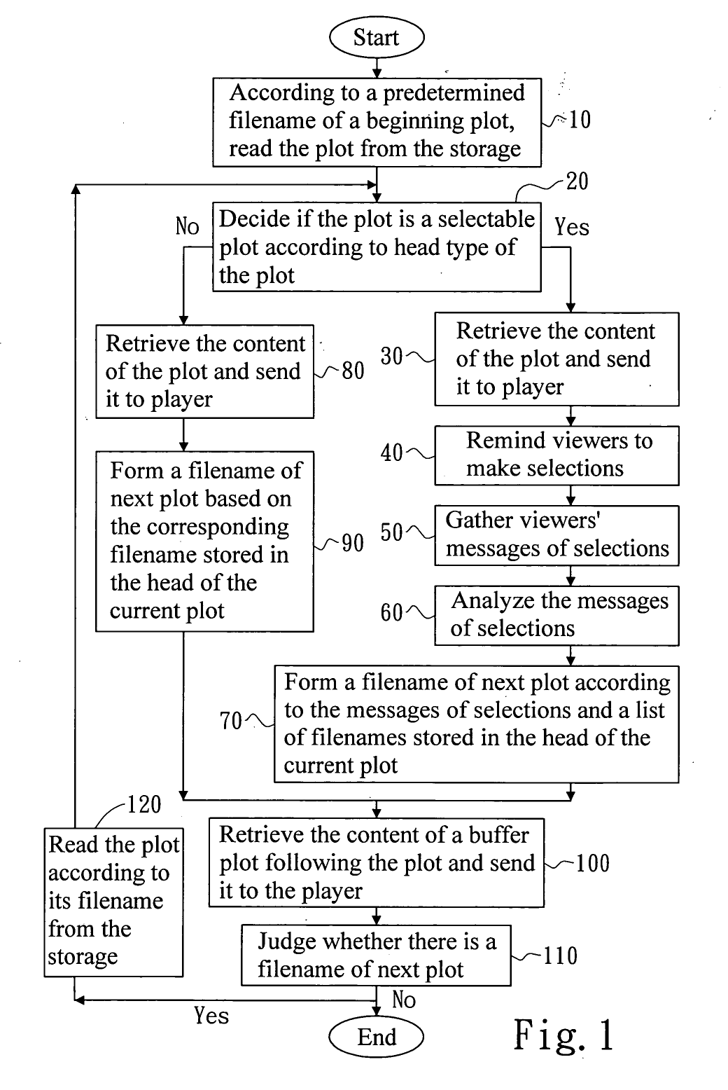

Please refer to FIG. 1, which shows a flowchart of a playing process according to the present invention and hereby described as following:

Step 10: according to a predetermined filename of a beginning plot, read the plot from the storage.

Step 20: Decide if the beginning plot is a selectable plot according to head type of the plot.

If the beginning plot is a selectable plot, go to step 30: Retrieve the content of the plot and send it to a player.

During the playing process, selectable plots are set at certain scenarios. For example, a selectable plot may be set at a scenario that a lead has to make a choice. Therefore, viewers can select different screenplays to be played according to their preference.

Step 40: Remind viewers to select subsequent screenplays, wherein the time for viewers to make decisions is controlled by a time controller.

Step 50 and 60: Gather and analyze the massages of selections from the viewers and obtain a corresponding result.

Step 70: Form a filename of next plot based on the result and a list of corresponding filenames stored in the head of the current plot.

In step 20, if the beginning plot is a general plot rather than a selectable plot, go to step 80: Retrieve the content of the plot and send it to the player.

Step 90: Form a filename of next plot according to the corresponding filename stored in the head of the current plot.

Step 100: Retrieve the content of a buffer plot following the plot and send it to the player.

Step 110: Judge if there is a filename of next plot while play the buffer plot; if there is a filename of next plot, go to step 120; if there is no filename of next plot, terminate the playing.

Step 120: Read a plot according to its filename from the storage. Repeat step 20 to 120 until the playing process is complete.

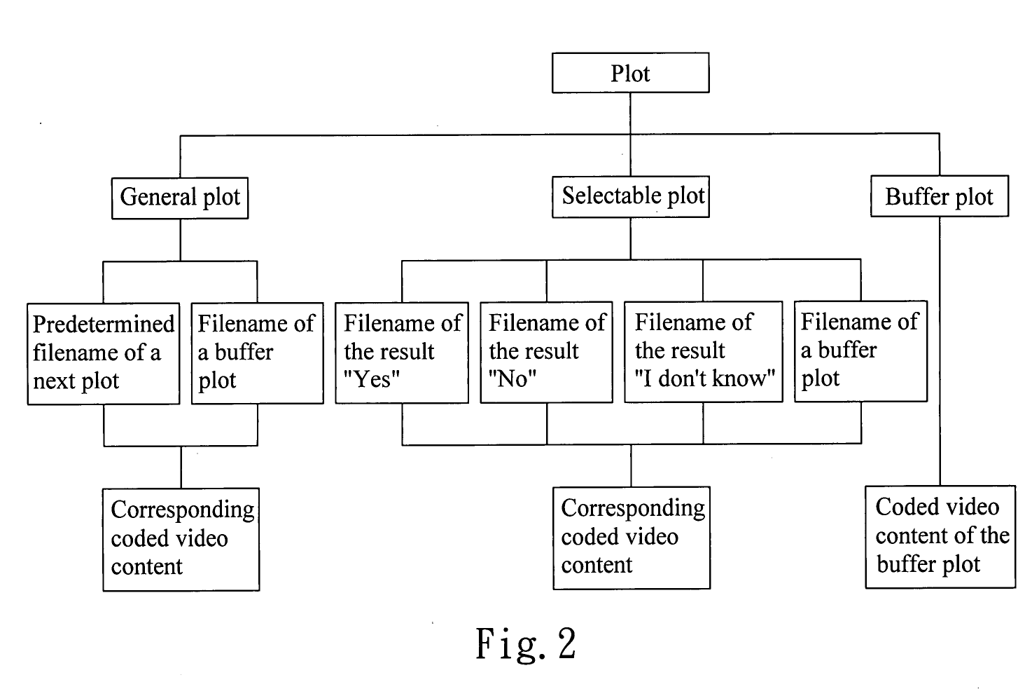

FIG. 2 is a structural diagram showing one plot according to the present invention. The head of the beginning plot includes information concerning types and filenames of plots. Plots can be classified into two kinds: a general plot and a selectable plot. The general plot has one filename of a plot and one filename of a buffer plot predetermined by a director. The selectable plot has three filenames of screenplays (the filenames of the results “Yes”, “No”, and “I don't know”) and one filename of a buffer plot. In each plot, each filename has a corresponding decoded video content. Besides, as shown in FIG. 2, there could be a further kind of buffer plot, and the buffer plot has a corresponding coded video content.

According to the screenplay-selectable video displaying method of the present invention, the method can be used for playing a video in a computer, a theater, and a digital television. The messages of selections are made by viewers via voters, Internet, telephones, or/and messages of mobile phones. The voter can be a group of selecting keys additively disposed on a remote controller for a digital television, a PC voter for a theater, or a mouse or certain specific keys on a keyboard for a computer. The selecting keys of the voter are “Yes” and “No” keys respectively representing different selections of plots of different screenplays. Three results “Yes”, “No”, and “I don't know” can be produced based on the messages of selections from the viewers.

When a video is viewed by only one viewer, if the viewer presses a selecting key of “Yes” or “No”, a result “Yes” or “No” will be produced correspondingly. A corresponding filename of the result “Yes” or “No” will be obtained according to the result and the video will be decoded and played according to the filename. If the viewer gives up selecting the keys, a result “I don't know” is produced. A corresponding filename of the result “I don't know” will be obtained according to the result and the video is retrieved, decoded, and played according to the filename.

When a video is viewed by many viewers, for example in a theater, viewers can select the keys within the time determined by a time controller and the messages of selections from the viewers are gathered and analyzed. If more viewers select “Yes” rather than “No”, the result “Yes” is produced. If more viewers select “No” rather than “Yes”, the result “No” is produced. A corresponding filename of the result “Yes” or “No” is obtained based on the result and the video is decoded and played according to the filename. If the viewers give up selecting the keys, a result “I don't know” is produced. A corresponding filename of the result “I don't know” is obtained based on the result, and the video is retrieved, decoded, and played according to the filename.

The time for viewers to make decisions is controlled by a time controller. If the time is longer than that predetermined by the time controller, it will be regarded that viewers give up making selections by playing flow, the result “I don't know” will be obtained and the filename of the result “I don't know” is retrieved. Corresponding coded video content will be retrieved, decoded, and played.

It should be understood that different modifications and variations could be made from the disclosures of the present invention by the people familiar in the art, which should be deemed without departing the spirit of the present invention. For example, the selecting keys can be keys presented by “S1”, “S2”, . . . “SN”, and “Give up”. The messages of selections are gathered and analyzed after the viewers make decisions and the result is one selected by majority of the viewers.

What is claimed is:

1. A screenplay-selectable video displaying method for playing a video after that a beginning plot is read from the storage according to a predetermined filename of the beginning plot, comprising steps of:
a. retrieving a head of the beginning plot and decide if the plot is a selectable plot or a general plot, wherein if the plot is a selectable plot, then play the plot, remind viewers to make selections on the following scenario result, and go to step b; if the plot is a general plot, then play the plot, form a name of next plot according to a filename of the next plot stored in head of the beginning plot, and go to step d;
b. gathering and analyzing the messages of selections from the viewers and obtaining a corresponding result while playing the plot;
c. retrieving a filename list corresponding to the value of the corresponding screenplay stored in the head of the selectable beginning plot according to the result and forming a filename of next plot according to the list;
d. retrieving a buffer plot following the plot and decoding and playing the coded content of the buffer plot;
e. judging if there is a filename of next plot while the buffer plot is played in step d, where if a filename can be retrieved, go to step a; if there is no filename of next plot, terminate the playing.

2. The screenplay-selectable video displaying method as claimed in claim 1, which is characterized in that: the head of the beginning plot includes information concerning types and filenames of plots of screenplays, where the types of plots include a general plot and a selectable plot.

3. The screenplay-selectable video displaying method as claimed in claim 2, which is characterized in that: general plot has one filename of a plot and one filename of a buffer plot, which are predetermined by a director.

4. The screenplay-selectable video displaying method as claimed in claim 2, which is characterized in that: the selectable plot has different plot filenames of different screenplays and one filename of a buffer plot.

5. The screenplay-selectable video displaying method as claimed in claim 1, which is characterized in that: the time taken by viewers to make decisions is controlled by a time controller, wherein if the time is longer than that predetermined by the time controller, it will be regarded that viewers give up making selections by playing flow, which will play the plot of a screenplay predetermined by a director.

6. The screenplay-selectable video displaying method as claimed in claim 2, which is characterized in that: the time taken by viewers to make decisions is controlled by a time controller, wherein if the time is longer than that predetermined by the time controller, it will be regarded that viewers give up making selections by playing flow, which will play the plot of a screenplay predetermined by a director.

7. The screenplay-selectable video displaying method as claimed in claim 3, which is characterized in that: the time taken by viewers to make decisions is controlled by a time controller, wherein if the time is longer than that predetermined by the time controller, it will be regarded that viewers give up making selections by playing flow, which will play the plot of a screenplay predetermined by a director.

8. The screenplay-selectable video displaying method as claimed in claim 4, which is characterized in that: the time taken by viewers to make decisions is controlled by a time controller, wherein if the time is longer than that predetermined by the time controller, it will be regarded that viewers give up making selections by playing flow, which will play the plot of a screenplay predetermined by a director.

9. The screenplay-selectable video displaying method as claimed in claim 1, which is characterized in that: the messages of selections are made by viewers via voters, Internet, telephones, or/and messages of mobile phones; the voter is a group of selecting keys additively disposed on a remote controller for a digital television, a PC voter for a theater, or a mouse or certain specific keys on a keyboard for a computer.

10. The screenplay-selectable video displaying method as claimed in claim 2, which is characterized in that: the messages of selections are made by viewers via voters, Internet, telephones, or/and messages of mobile phones; the voter is a group of selecting keys additively disposed on a remote controller for a digital television, a PC voter for a theater, or a mouse or certain specific keys on a keyboard for a computer.

11. The screenplay-selectable video displaying method as claimed in claim 3, which is characterized in that: the messages of selections are made by viewers via voters, Internet, telephones, or/and messages of mobile phones; the voter is a group of selecting keys additively disposed on a remote controller for a digital television, a PC voter for a theater, or a mouse or certain specific keys on a keyboard for a computer.

12. The screenplay-selectable video displaying method as claimed in claim 4, which is characterized in that: the messages of selections are made by viewers via voters, Internet, telephones, or/and messages of mobile phones; the voter is a group of selecting keys additively disposed on a remote controller for a digital television, a PC voter for a theater, or a mouse or certain specific keys on a keyboard for a computer.

13. The screenplay-selectable video displaying method as claimed in claim 9, which is characterized in that: the selecting keys of the voter are “Yes” and “No” keys respectively representing different selections of plots of different screenplays and “Yes” and “No” are produced according to the messages of selections from the viewers; if viewers give up making selections or the selected result values of “Yes” and “No” are identical, “I don't know” is produced; the three results correspond to three filenames of the results “Yes”, “No”, and “I don't know”.

14. The screenplay-selectable video displaying method as claimed in claim 10, which is characterized in that: the selecting keys of the voter are “Yes” and “No” keys respectively representing different selections of plots of different screenplays and “Yes” and “No” are produced according to the messages of selections from the viewers; if viewers give up making selections or the selected result values of “Yes” and “No” are identical, “I don't know” is produced; the three results correspond to three filenames of the results “Yes”, “No”, and “I don't know”.

15. The screenplay-selectable video displaying method as claimed in claim 11, which is characterized in that: the selecting keys of the voter are “Yes” and “No” keys respectively representing different selections of plots of different screenplays and “Yes” and “No” are produced according to the messages of selections from the viewers; if viewers give up making selections or the selected result values of “Yes” and “No” are identical, “I don't know” is produced; the three results correspond to three filenames of the results “Yes”, “No”, and “I don't know”.

16. The screenplay-selectable video displaying method as claimed in claim 12, which is characterized in that: the selecting keys of the voter are “Yes” and “No” keys respectively representing different selections of plots of different screenplays and “Yes” and “No” are produced according to the messages of selections from the viewers; if viewers give up making selections or the selected result values of “Yes” and “No” are identical, “I don't know” is produced; the three results correspond to three filenames of the results “Yes”, “No”, and “I don't know”.

17. The screenplay-selectable video displaying method as claimed in claim 9, which is characterized in that: the voter is used for selecting different selectable plots in the same video.

18. The screenplay-selectable video displaying method as claimed in claim 10, which is characterized in that: the voter is used for selecting different selectable plots in the same video.

19. The screenplay-selectable video displaying method as claimed in claim 11, which is characterized in that: the voter is used for selecting different selectable plots in the same video.

20. The screenplay-selectable video displaying method as claimed in claim 12, which is characterized in that: the voter is used for selecting different selectable plots in the same video.
